(19) United States
(12) Patent Application Publication
(10) Pub. No.: US 2010/0241932 A1
(43) Pub. Date: Sep. 23, 2010

(54) ERROR DETECTOR/CORRECTOR, MEMORY CONTROLLER, AND SEMICONDUCTOR MEMORY DEVICE

(75) Inventors: Kenji SAKAUE, Kanagawa (JP); Yukio Ishikawa, Kanagawa (JP); Shigeru Inada, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/556,748

(22) Filed: Sep. 10, 2009

(30) Foreign Application Priority Data
Mar. 17, 2009 (JP) 2009-064796

(51) Int. Cl. G06F 11/08

(52) U.S. Cl. 714/784; 714/E11.03

(57) ABSTRACT

An error detector/corrector includes an ECC cache unit configured to store an error bit address which represents an error location by associating the error bit address with an error page address and a coefficient α of an error location polynomial; a comparison unit configured to check for a match by comparing new values with stored values, where the new values are an error page address detected by a syndrome calculation unit and a coefficient α of the error location polynomial calculated by a polynomial calculation unit while the stored values are an error page address and a coefficient α of the error location polynomial stored in the ECC cache unit; and a first error localization unit configured to identify a location of the error bit address stored in the ECC cache unit as the error location when the comparison unit determines that the compared values match.

### CROSS-REFERENCE TO RELATED APPLICATION

This application is based upon and claims the benefit of priority from the prior Japanese Patent Application No. 2009-064796, filed in Japan on Mar. 17, 2009; the entire contents of which are incorporated herein by reference.

### BACKGROUND OF THE INVENTION

1. Field of the Invention

The present invention relates to an error detector/corrector, memory controller, and semiconductor memory device, and more particularly, to an error detector/corrector, memory controller, and semiconductor memory device which detect and correct errors in encoded data read on a page-by-page basis out of a NAND flash memory unit made up of multiple memory cells.

2. Description of Related Art

An error detector/corrector of a semiconductor memory device has an encoder and decoder. That is, when data is stored, the error detector/corrector generates encoded data, by adding error correcting codes such as BCH (Bose-Chaudhuri-Hocquenghem) codes or Reed Solomon (RS) codes using the encoder, where the Reed Solomon codes are linear block codes of the BCH codes. When stored, encoded data is read, the error detector/corrector detects and corrects errors using the decoder.

Both BCH code and Reed Solomon code are formed using a primitive polynomial over a Galois field and nature of a root of the primitive polynomial. However, the BCH code and Reed Solomon code differ from each other in that the BCH code handles data in units of one bit with error correcting codes being generated in units of bits while the Reed Solomon code handles data in units of eight bits (=1 byte) with error correcting codes being generated in units of bytes.

The decoder processes encoded data produced by adding BCH codes or Reed Solomon codes to data, in the following order: (1) error checking step, (2) error counting step (error location polynomial calculation step), (3) error location calculation step, and (4) error correction step.

For example, a Chien search method is used in the error location calculation step. The Chien search method assigns all possible values—for example, 0 to M (where M is final bit position or final byte position of data)—in sequence to a variable X of an n-th order error location polynomial calculated in the error location polynomial calculation step and thereby searches for values which satisfy the error location polynomial. When all N solutions are identified, i.e., when all N error locations are identified, an error correction unit corrects erroneous data in batches and outputs corrected data. If an error location is in final part of the data, i.e., if an error is found in the final value assigned during the Chien search, the data is not corrected and outputted until the final value M in the Chien search is assigned. Consequently, it can take time to complete a decoding process and output the data, resulting in increased power consumption.

Thus, known error detector/correctors, memory controllers equipped with such an error detector/corrector, and semiconductor memory devices equipped with such an error detector/corrector can be slow in processing speed and high in power consumption, i.e., poor in decoding efficiency.

### BRIEF SUMMARY OF THE INVENTION

According to one aspect of the present invention, there is provided an error detector/corrector which detects whether or not there is an error in an encoded data string read on a page-by-page basis and corrects any error in the encoded data string, including: an error detection unit configured to detect whether or not there is an error in the encoded data string read on a page-by-page basis; a polynomial calculation unit configured to calculate an error location polynomial; an error location storage unit configured to store an error address which represents an error location by associating the error address with at least one of an error page address which represents a location of a page containing an error and a coefficient of the error location polynomial; a comparison unit configured to check for a match by comparing at least one of an error page address newly detected by the error detection unit and a coefficient of the error location polynomial newly calculated by the polynomial calculation unit with at least one of the error page address and the coefficient of the error location polynomial, already stored in the error location storage unit; a first error localization unit configured to identify a location of the error address stored in the error location storage unit by being associated with at least one of the error page address and the coefficient of the error location polynomial, as the error location when the comparison unit determines that compared values match; a second error localization unit configured to calculate an error location from the error location polynomial when the comparison unit determines that the compared values do not match; and an error correction unit configured to correct any data error at the error location.

According to another aspect of the present invention, there is provided a memory controller which detects whether or not there is an error in an encoded data string read on a page-by-page basis and corrects any error in the encoded data string, including: an error detection unit configured to detect whether or not there is an error in the encoded data string read on a page-by-page basis; a polynomial calculation unit configured to calculate an error location polynomial; an error location storage unit configured to store an error address which represents an error location by associating the error address with at least one of an error page address which represents a location of a page containing an error and a coefficient of the error location polynomial; a comparison unit configured to check for a match by comparing at least one of an error page address newly detected by the error detection unit and a coefficient of the error location polynomial newly calculated by the polynomial calculation unit with at least one of the error page address and the coefficient of the error location polynomial, already stored in the error location storage unit; a first error localization unit configured to identify a location of the error address stored in the error location storage unit by being associated with at least one of the error page address and the coefficient of the error location polynomial, as the error location when the comparison unit determines that compared values match; a second error localization unit configured to calculate an error location from the error location polynomial when the comparison unit determines that the compared values do not match; and an error correction unit configured to correct any data error at the error location.

According to another aspect of the present invention, there is provided a semiconductor memory device which detects whether or not there is an error in an encoded data string read on a page-by-page basis and corrects any error in the encoded data string, including: an error detection unit configured to detect whether or not there is an error in the encoded data string read on a page-by-page basis; a polynomial calculation unit configured to calculate an error location polynomial; an error location storage unit configured to store an error address which represents an error location by associating the error address with at least one of an error page address which represents a location of a page containing an error and a coefficient of the error location polynomial; a comparison unit configured to check for a match by comparing at least one of an error page address newly detected by the error detection unit and a coefficient of the error location polynomial newly calculated by the polynomial calculation unit with at least one of the error page address and the coefficient of the error location polynomial, already stored in the error location storage unit; a first error localization unit configured to identify a location of the error address stored in the error location storage unit by being associated with at least one of the error page address and the coefficient of the error location polynomial, as the error location when the comparison unit determines that compared values match; a second error localization unit configured to calculate an error location from the error location polynomial when the comparison unit determines that the compared values do not match; and an error correction unit configured to correct any data error at the error location.

### BRIEF DESCRIPTION OF THE DRAWINGS

FIG. 1 is a block diagram showing a configuration of a semiconductor memory device according to a first embodiment;

FIG. 2 is a block diagram showing a configuration of the semiconductor memory device according to the first embodiment;

FIG. 3 is an explanatory diagram illustrating a decoding process performed by an error detector/corrector according to the first embodiment;

FIG. 4 is a flowchart illustrating a flow of the decoding process performed by the error detector/corrector according to the first embodiment;

FIG. 5 is an explanatory diagram illustrating a decoding process performed by an error detector/corrector according to a second embodiment;

FIG. 6 is an explanatory diagram illustrating a decoding process performed by an error detector/corrector according to a third embodiment;

FIG. 7 is an explanatory diagram illustrating a decoding process performed by an error detector/corrector according to a fourth embodiment; and

FIG. 8 is an explanatory diagram illustrating a decoding process performed by an error detector/corrector according to a fifth embodiment.

### DETAILED DESCRIPTION OF THE INVENTION

### First Embodiment

An error detector/corrector, a memory controller 10 equipped with the error detector/corrector, and a semiconductor memory device 2 equipped with the error detector/corrector according to a first embodiment of the present invention (hereinafter referred to as the “error detector/corrector and the like”) will be described below with reference to the drawings.

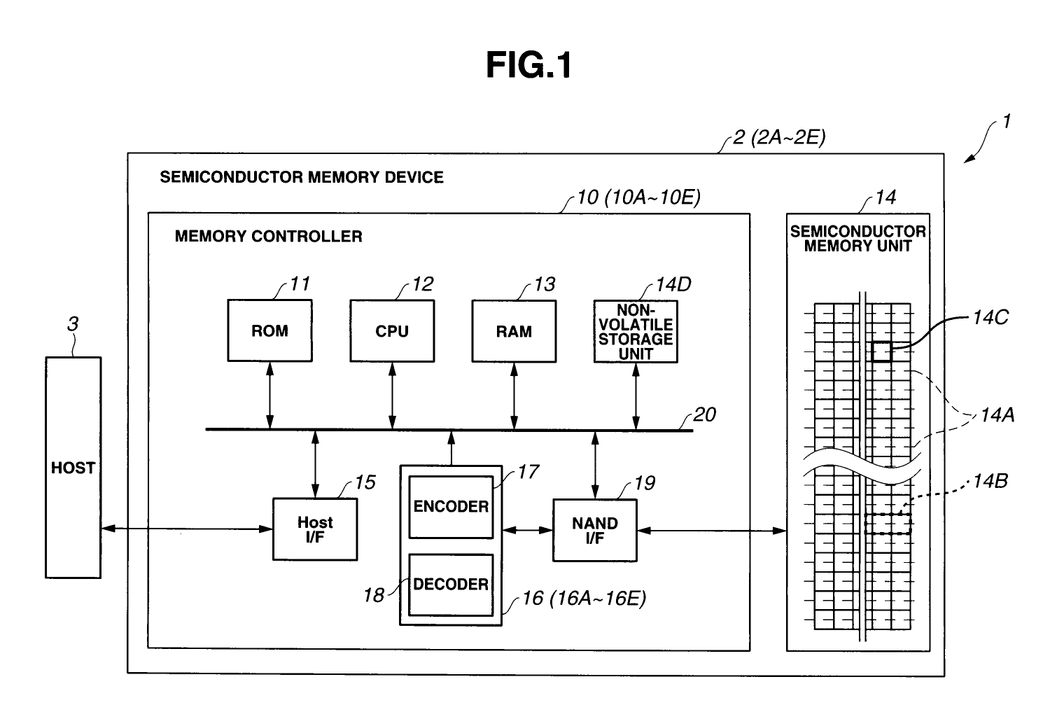

As shown in FIG. 1, the semiconductor memory device 2 according to the present embodiment is a storage medium detachably connected to a host 3 such as a personal computer or digital camera and takes the form of, for example, a memory card. Alternatively, the semiconductor memory device according to the present embodiment may be a so-called embedded memory device which stores boot data and the like for the host, being contained in the host, or a semiconductor disk such as an SSD (solid state drive). Alternatively, the semiconductor memory device 2 and host 3 may make up, for example, a memory system 1 of an MP3 player or the like, where the MP3 player is a portable music player. The semiconductor memory device 2 includes a memory unit 14 and a memory controller 10. The memory unit 14 is a NAND flash memory unit in which a large number of memory cells 14C serving as unit cells are connected via bit lines (not shown) used for writing, word lines 14A used for reading, and the like.

In the semiconductor memory device 2 equipped with the NAND flash memory unit, multiple memory cells 14C are arranged in an array so that data stored in a predetermined number of memory cells 14C can be erased all together. Units in which the predetermined number of memory cells are erased together are referred to as blocks. On the other hand, data stored in the memory cells 14C is read in units smaller than the blocks, i.e., in units of pages 14B schematically shown in FIG. 1. That is, each page 14B is made up of multiple memory cells 14C, each block is made up of multiple pages 14B, and the memory unit 14 is made up of multiple blocks.

The memory controller 10 includes a ROM 11, a CPU 12 which is a control unit, a RAM 13 which also functions as a data buffer, a host I/F (interface) 15, an error detector/corrector (hereinafter also referred to as ECC) 16, a NAND I/F (interface) 19, and a non-volatile storage unit 14D, all of which are connected via a bus 20. The ECC 16 includes an encoder 17 which encodes data to be stored and a decoder 18 which decodes stored data. It is assumed that the ECC described below uses BCH codes. Using the CPU 12, the memory controller 10 exchanges data with the host 3 via the host I/F 15 and exchanges data with the memory unit 14 via the NAND I/F 19.

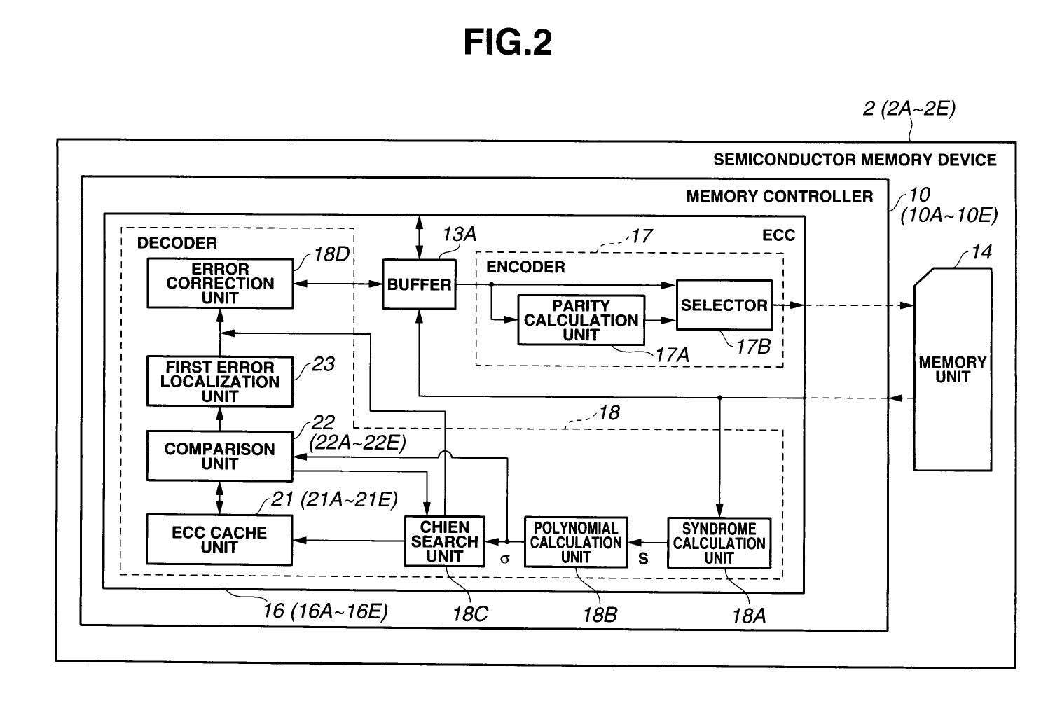

As shown in FIG. 2, the decoder 18 of the ECC 16 includes a syndrome calculation unit 18A, a polynomial calculation unit 18B, a Chien search unit 18C, and an error correction unit 18D, where the Chien search unit 18C is a second error localization unit. The syndrome calculation unit 18A is a detection unit which calculates a syndrome S and detects whether or not there is an error in encoded data read out of the memory unit 14 on a page-by-page basis. The polynomial calculation unit 18B calculates an error location polynomial. The Chien search unit 18C is an error localization unit which searches for and identifies an error location based on the error location polynomial, as already described. The error correction unit 18D corrects the error at the identified error location.

With the semiconductor memory device 2 which stores data in the memory unit 14 made up of multiple memory cells 14C, if errors in the stored data are caused by physical factors of the memory unit 14 such as deterioration of specific memory cells 14C, a failure mode with a fixed error location occurs each time data is stored in, or read from, the deteriorated memory cells 14C. In a failure mode with a fixed error location, an error occurs repeatedly at the same location on the same page.

Consequently, if an error bit address, i.e., an error address which represents the error location, is stored by being associated with at least one of an error page address which represents the location of the page containing the error and a coefficient α of the error location polynomial (hereinafter also referred to as the “coefficient”), when an error occurs again on the page with the same page address, the error location can be identified in a simple manner even if the Chien search unit 18C which requires a long processing time does not perform an error localization process.

Incidentally, the error address, which is an error bit address when BCH-encoded data is decoded, for example, is an error byte address when RS-encoded data is decoded.

That is, as shown in FIG. 2, the ECC 16 according to the present embodiment has an ECC cache unit 21, a comparison unit 22, and a first error localization unit 23 to identify error locations easily. The ECC cache unit 21 is an error location storage unit which stores the error bit address which represents the error location by associating the error bit address with the error page address which represents the location of the page containing the error and the coefficient α of the error location polynomial.

The comparison unit 22 checks for a match by comparing an error page address newly detected by the syndrome calculation unit 18A and a coefficient α of the error location polynomial newly calculated by the polynomial calculation unit 18B with the error page address and the coefficient α of the error location polynomial, stored in the ECC cache unit 21. When the comparison unit 22 determines that there is a match, the first error localization unit 23 identifies the location represented by the error bit address stored in the ECC cache unit 21 by being associated with the error page address and the coefficient of the error location polynomial, as the error location.

Incidentally, the ECC cache unit 21, the comparison unit 22, the first error localization unit 23, or the non-volatile storage unit 14D may not be an independent component, and may be a component of the memory controller 10 or the semiconductor memory device 2. For example, the ECC cache unit 21 may be a register in the CPU 12 or part of the RAM 13 while the comparison unit 22 and first error localization unit 23 may be implemented as FW (Firm Ware) executed by the CPU 12.

When a frequently-accessed specific page (hereinafter referred to as a “special page”)—for example, a frequently-accessed page which stores system management information such as a logical/physical page address conversion table—is in a failure mode with a fixed error location, advantages of the error detector/corrector and the like according to the present embodiment are significant. Consequently, the error detector/corrector 16 can reduce capacity of the ECC cache unit 21 by identifying only the error locations of errors on special pages in a simplified manner using the first error localization unit 23. Of course, if the error detector/corrector and the like permit the ECC cache unit 21 to have large capacity, error information about regular pages other than special pages may also be stored in the ECC cache unit 21. That is, specifications of the ECC cache unit 21 are optimized according to the memory system 1.

On the other hand, when it is desirable for the error detector/corrector and the like to reduce the capacity of the ECC cache unit 21, conditions for storing error information in the ECC cache unit 21 may be set such as to accept only special pages on which the number of errors reaches or exceeds a certain value.

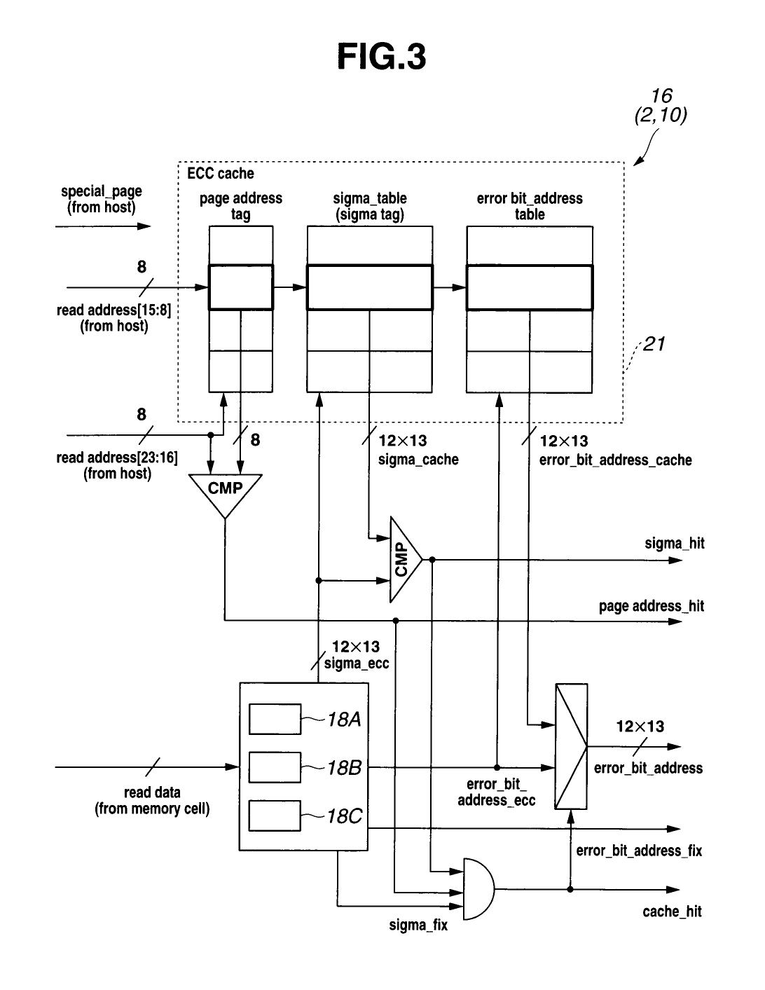

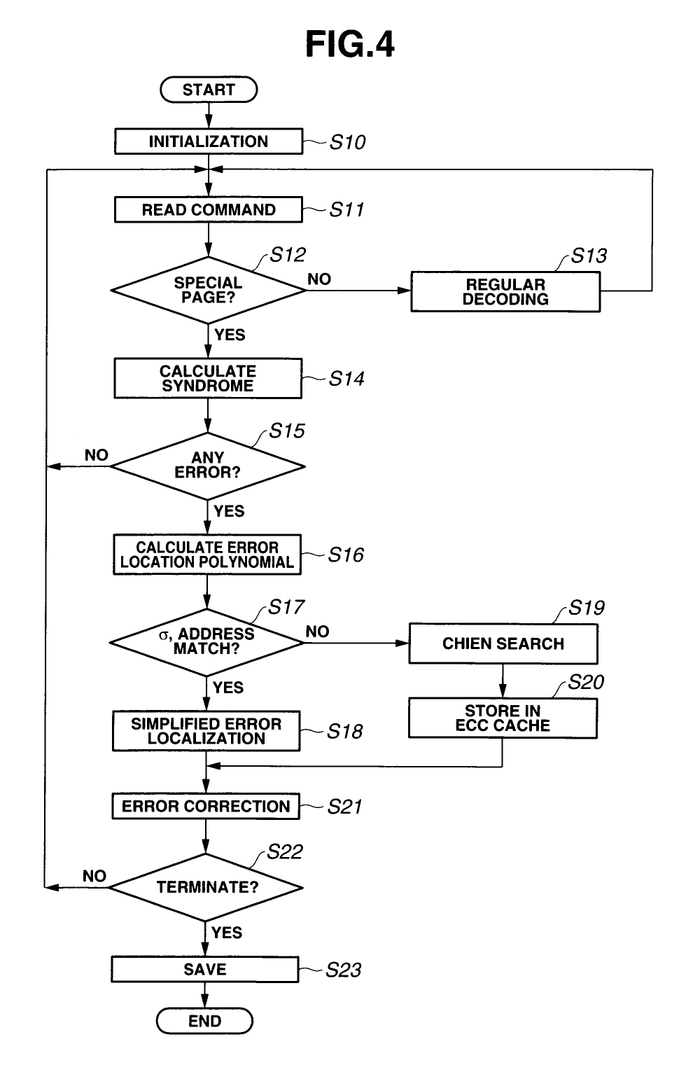

Next, a flow of processes performed by the error detector/corrector and the like according to the present embodiment will be described with reference to FIGS. 3 and 4. FIG. 3 shows an exemplary process flow of the error detector/corrector and the like which uses the upper 16 bits of 24 address bits as a page address. Out of the 16 bits of the page address, the lower 8 bits are used for an address of the ECC cache unit and the upper 8 bits are used for a “page address tag.” Regarding data stored in the ECC cache unit 21, the coefficient α uses 156 bits (=13 bits×12) and error page addresses use 156 bits (=13 bits×12).

FIG. 4 is a flowchart illustrating a flow of a decoding process performed by the error detector/corrector 16. Description will be given below with reference to FIG. 4.

<Step S10> Initialization Step

On start-up, the error detector/corrector 16 reads information and the like of the ECC cache unit 21 which existed before the previous shutdown out of the non-volatile storage unit 14D and stores the information and the like in the ECC cache unit 21.

<Step S11> Writing Step (Encoding Step)

The error detector/corrector 16 encodes data inputted in response to a write command from the host 3, i.e., adds parity data to the inputted data and stores the resulting data in the memory unit 14.

For example, the encoder 17 of the error detector/corrector 16 adds BCH-coded overall parity data for 12-bit correction to 8 Kbits of page data. That is, the overall parity data is 156 bits (=13×12). The encoded data with the parity data added is stored in the memory unit 14.

<Step S12> Special-Page Reading Step

When instructed to read a page by a read command from the host 3, the syndrome calculation unit 18A, the CPU 12, or the like determines whether or not the page to be read out is a special page. A special page access is identified using an identification signal “special_page” from the host 3. Special pages are defined in advance in the memory system 1. If the page to be accessed is not a special page, but a regular page (No in S12), a regular decoding process is performed in Step S13 via a syndrome calculation process.

<Step S14> Syndrome Calculation Step

If the page to be accessed is a special page (Yes in S12), the syndrome calculation unit 18A calculates a syndrome S from encoded data on the special page read out of the memory unit 14. That is, the syndrome calculation unit 18A performs a syndrome calculation process on regular pages as well as on special pages.

<Step S15> Error Checking Step

When a calculated syndrome value is zero, meaning that the number N of errors is zero, there is no need to perform an error correction process, and thus the data on the page is outputted to the host 3 via the host interface 15.

<Step S16> Error Location Polynomial Calculation Step

When the calculated syndrome value is not zero, the polynomial calculation unit 18B calculates an error location polynomial based on the syndrome. The polynomial calculation unit 18B performs an error location polynomial calculation process similarly for both special page and regular page.

<Step S17> Comparison Step

The comparison unit 22 checks for a match by comparing new values with stored values, where the new values are the page address containing the error detected by the syndrome calculation unit 18A and the coefficient α of the error location polynomial calculated by the polynomial calculation unit 18B while the stored values are the error page address and coefficient α of the error location polynomial, stored in the ECC cache unit 21.

In other words, based on the page address, the comparison unit 22 accesses the ECC cache unit 21 and determines whether there is any entry which matches the “page address tag.” Of course, if no error data is stored in the ECC cache unit 21, the comparison unit 22 does not need to operate.

<Step S18> Simplified Error Localization Step

When the comparison unit 22 determines that there is a match between the compared values, i.e., that the page address detected by the syndrome calculation unit 18A and the coefficient α calculated by the polynomial calculation unit 18B match the error page address and coefficient α stored in the ECC cache unit 21, the first error localization unit 23 identifies, as an error location, the location represented by the error bit address stored in the ECC cache unit 21 by being associated with the error page address and the coefficient of the error location polynomial.

In FIG. 3, “sigma_fix” is a timing signal which indicates that the polynomial calculation unit 18B has finished calculating the coefficient α and “error_bit_address_fix” is a timing signal which indicates that calculation of the error bit address has been finished. The two signals are used to finally determine the error bit address which represents the error location.

<Step S19> Chien Search Step

When the comparison unit 22 determines that there is no match or when the page addresses (page address tags) match, but the coefficients α (sigma tags) do not match, the Chien search unit 18C identifies an error location based on the error location polynomial using a Chien search, as in the case of a regular-page decoding process.

<Step S20> ECC Caching Step

The error location calculated by the Chien search unit 18C, the error page address, and the coefficient α of the error location polynomial—which is a parameter used to calculate the error location—are stored in the ECC cache unit 21 for future use in a simplified error localization process.

The page information is stored in empty entries in the ECC cache unit 21. That is, the coefficient α calculated by the polynomial calculation unit is stored in “sigma_table” and the error bit address is stored in “error_bit_address_table.”

If no space is available in the ECC cache unit 21 to store information such as the error page address, old entries are replaced with new entries based on a predetermined replacement algorithm. Available replacement algorithms include a random-replacement algorithm and an LRU (least recently used) replacement algorithm (which replaces entries on the least recently accessed page).

<Step S21> Error Correction

The error correction unit 18D corrects the error at the identified error location. The error correction carried out by the error correction unit 18D involves bit flipping in the case of encoded data containing BCH codes. In the case of encoded data containing Reed Solomon codes, the error correction unit 18D calculates corrected values as 8-bit data by further solving simultaneous linear equations.

<Step S22> Terminate Instruction

The error detector/corrector 16 continues processing until a terminate instruction is received from the host.

<Step S23> Saving Step

When a terminate instruction is received from the host, the error detector/corrector 16 transfers, i.e., saves, the information stored in the ECC cache unit 21 to the non-volatile storage unit 14D. The non-volatile storage unit 14D may be part of the memory unit 14, or a magnetic hard disk drive (HDD) if the memory system 1 has one. Incidentally, the error detector/corrector 16 may perform a saving process not only in response to a terminate instruction from the host 3, but also at predetermined time intervals.

Although not described above, the error detector/corrector 16 performs each process by temporarily storing data in a data buffer such as a buffer 13A (see FIG. 2) or the RAM 13 and reading data from the data buffer. Besides, although data transfer between the error detector/corrector 16 and the memory unit 14 may be performed via the bus 20, the use of a dedicated bus is preferable for improved processing speed.

As described above, the error detector/corrector 16, memory controller 10, and semiconductor memory device 2 according to the present embodiment provide an efficient decoding process because the first error localization unit 23 can easily identify error locations even if the Chien search unit 18C which requires a long processing time does not perform an error localization process.

### Second Embodiment

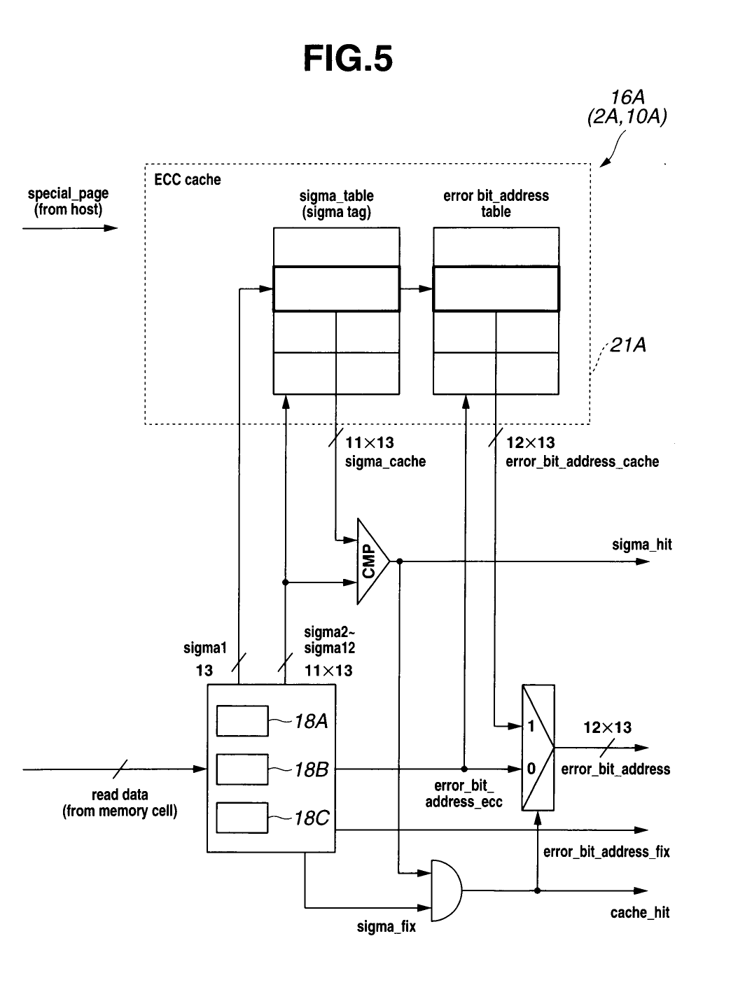

Next, a decoding process performed by an error detector/corrector 16A and the like according to a second embodiment of the present invention will be described with reference to FIG. 5. The error detector/corrector 16A and the like according to the second embodiment are similar to the error detector/corrector 16 and the like according to the first embodiment. Thus, the same components as those in the first embodiment are denoted by the same reference numerals as the corresponding components in the first embodiment, and description thereof will be omitted.

Whereas the ECC cache unit 21 of the error detector/corrector 16 and the like according to the first embodiment uses the error page address and the coefficient α as tags for the ECC cache unit, an ECC cache unit 21A of the error detector/corrector 16A according to the second embodiment uses only the coefficient α as a tag. Incidentally, the “tags” are “markers” which allow various states of data to be identified.

As shown in FIG. 5, if an error occurs during reading of a special page, the error detector/corrector 16A stores the error bit address in the ECC cache unit 21A by associating the error bit address with the coefficient α. In so doing, the error detector/corrector 16A uses part of the coefficient α as an ECC cache address, and the rest of the coefficient α as tags.

As described above, the error detector/corrector 16A according to the present embodiment includes the ECC cache unit 21A which stores a coefficient of the error location polynomial and an error bit address which represents an error location by associating the coefficient of the error location polynomial and the error bit address with each other, a comparison unit 22A which checks for a match by comparing a coefficient of the error location polynomial calculated by the polynomial calculation unit 18B with the coefficient α of the error location polynomial stored in the ECC cache unit 21A, and a first error localization unit 23 which identifies a location of the error bit address stored in the ECC cache unit 21A by being associated with the coefficient of the error location polynomial, as the error location when the comparison unit 22A determines that compared values match.

Also, in the error detector/corrector 16A according to the present embodiment, the ECC cache unit 21A stores the error bit address using the coefficient α of the error location polynomial as a cache address which represents a storage location in the ECC cache unit 21A.

Consequently, the error detector/corrector 16A, a memory controller 10A (see FIGS. 1 and 2), and a semiconductor memory device 2A (see FIGS. 1 and 2) according to the present embodiment can reduce capacity by an amount equivalent to the address tags of the ECC cache unit 21A and eliminate address tag control logic. Thus, the error detector/corrector 16A according to the present embodiment not only provides advantages of the error detector/corrector 16 and the like according to the first embodiment, but also achieves cost and size reductions compared to the error detector/corrector 16 and the like according to the first embodiment.

### Third Embodiment

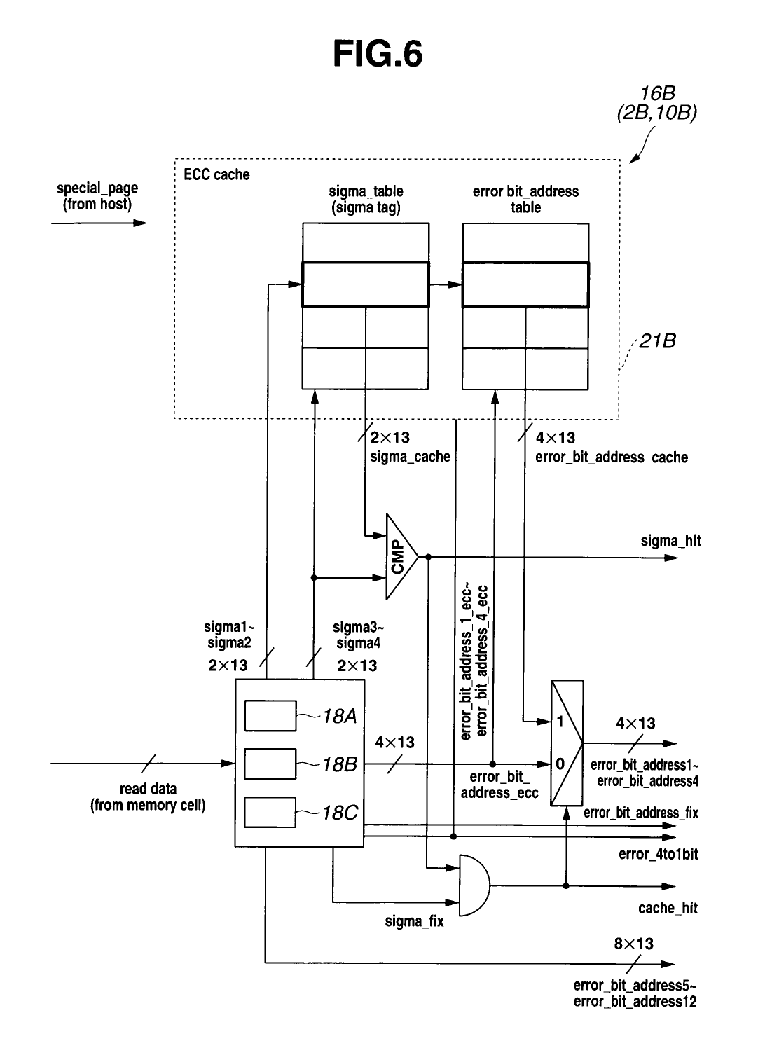

Next, a decoding process performed by an error detector/corrector 16B and the like according to a third embodiment of the present invention will be described with reference to FIG. 6. The error detector/corrector 16B and the like according to the third embodiment are similar to the error detector/corrector 16 and the like according to the first embodiment. Thus, the same components as those in the first embodiment are denoted by the same reference numerals as the corresponding components in the first embodiment, and description thereof will be omitted.

The coefficient α of the error location polynomial takes values which reflect the number of errors. For example, in the case of a 4-bit error, “sigma 5” to “sigma 12” are “0.” The error detector/corrector 16B according to the third embodiment takes advantage of this feature, and only pages containing a small number of errors are handled by an ECC cache unit 21B. In other words, the first error localization unit 23 identifies error locations on such pages in a simplified manner.

In the error detector/corrector 16B according to the present embodiment illustrated in FIG. 6 by way of example, only pages containing errors not larger than 4-bit errors are stored in the ECC cache unit 21B. Twenty-six (26) bits from “sigma 1” to “sigma 2” are allocated for addresses in the ECC cache unit 21B and 26 bits from “sigma 3” to “sigma 4” are allocated for tags. Up to four error page addresses (4×13 bits=52 bits) are stored. The error detector/corrector 16B according to the present embodiment operates in a manner similar to when tags 5 to 12 are set to “0” in the ECC cache unit 21A of the error detector/corrector 16A according to the second embodiment. When an error calculated by the polynomial calculation unit 18B does not exceed 4 bits, an “error_{—}4to1bit” signal is asserted (outputted) and a storage process is started to store the page in the ECC cache unit 21B.

The error detector/corrector 16B, a memory controller 10B (see FIGS. 1 and 2), and a semiconductor memory device 2B (see FIGS. 1 and 2) according to the present embodiment not only provide the advantages of the error detector/corrector 16 and the like according to the first embodiment, but also speed up the decoding process compared to the error detector/corrector 16 and the like according to the first embodiment because when the probability is high that there is a small number of errors, there is a high probability that a comparison process performed by the comparison unit 22B will produce a match. Also, the error detector/corrector 16B and the like according to the present embodiment can reduce the capacity of the error address table in the ECC cache unit 21B and thus achieve lower cost than the error detector/corrector 16 and the like according to the first embodiment.

On the other hand, when the probability is low that there is a small number of errors, since the error detector/corrector 16B and the like according to the present embodiment can reduce the volume of information stored in the ECC cache unit 21B, high decoding performance is available even if the ECC cache unit 21B has small capacity.

### Fourth Embodiment

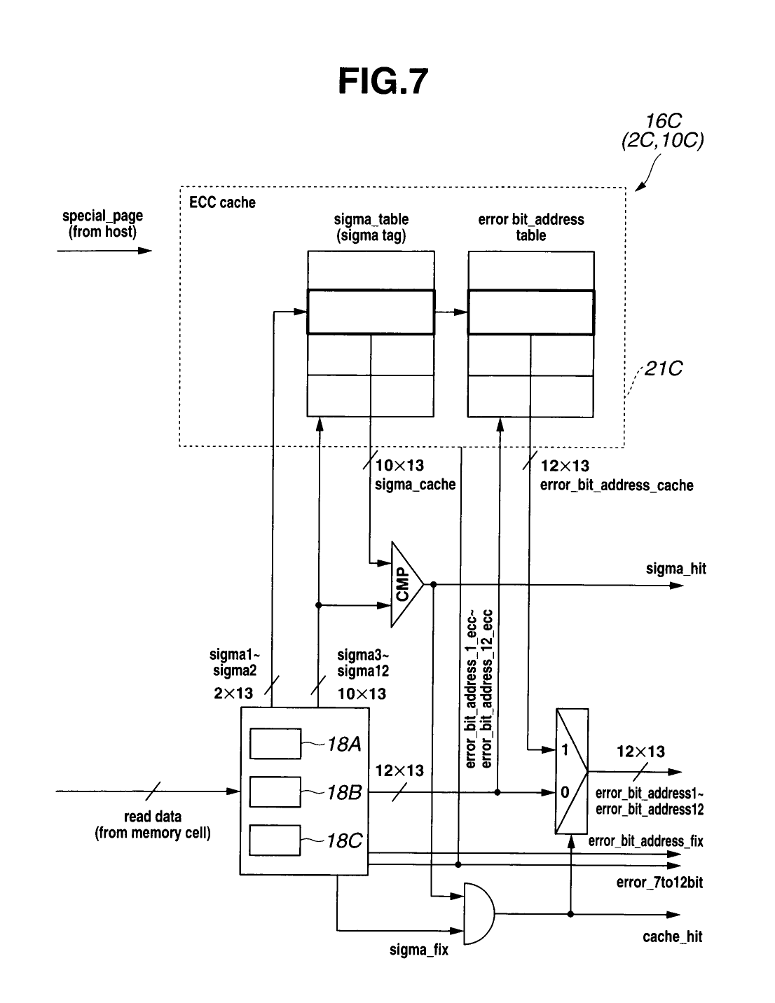

Next, a decoding process performed by an error detector/corrector 16C and the like according to a fourth embodiment of the present invention will be described with reference to FIG. 7. The error detector/corrector 16C and the like according to the fourth embodiment are similar to the error detector/corrector 16 and the like according to the first embodiment. Thus, the same components as those in the first embodiment are denoted by the same reference numerals as the corresponding components in the first embodiment, and description thereof will be omitted.

With the error detector/corrector 16B according to the third embodiment, only information about pages containing a small number of errors is stored in the ECC cache unit 21B. In contrast, as shown in FIG. 7, the error detector/corrector 16C according to the fourth embodiment stores information about pages containing a large number of errors—for example, seven or more errors—in an ECC cache unit 21C.

Consequently, the error detector/corrector 16C and the like according to the present embodiment not only provide the advantages of the error detector/corrector 16 and the like according to the first embodiment, but also speed up the decoding process compared to the error detector/corrector 16 and the like according to the first embodiment because when the probability is high that there is a large number of errors, there is a high probability that a comparison process performed by a comparison unit 22C will produce a match. Also, even when the processing time and power consumption of the Chien search unit 18C increases with the number of errors, the error detector/corrector 16C and the like according to the present embodiment can reduce the processing time and power consumption of the Chien search unit 18C more than the error detector/corrector 16 and the like according to the first embodiment because when there is a large number of errors, there is a high probability that a comparison process performed by the comparison unit 22C will produce a match, eliminating the need for Chien searches.

Conversely, when the probability is low that there is a large number of errors, since the error detector/corrector 16C and the like according to the present embodiment can reduce the absolute value of storage requirements for the ECC cache unit, high decoding performance can be obtained even if the ECC cache unit 21C has small capacity.

By caching only frequently-accessed pages which steadily contain a large number of errors, the error detector/corrector 16C, a memory controller 10C (see FIGS. 1 and 2), and a semiconductor memory device 2C (see FIGS. 1 and 2) according to the present embodiment can efficiently reduce the processing time required for decoding using the ECC cache unit 21C of small capacity.

### Fifth Embodiment

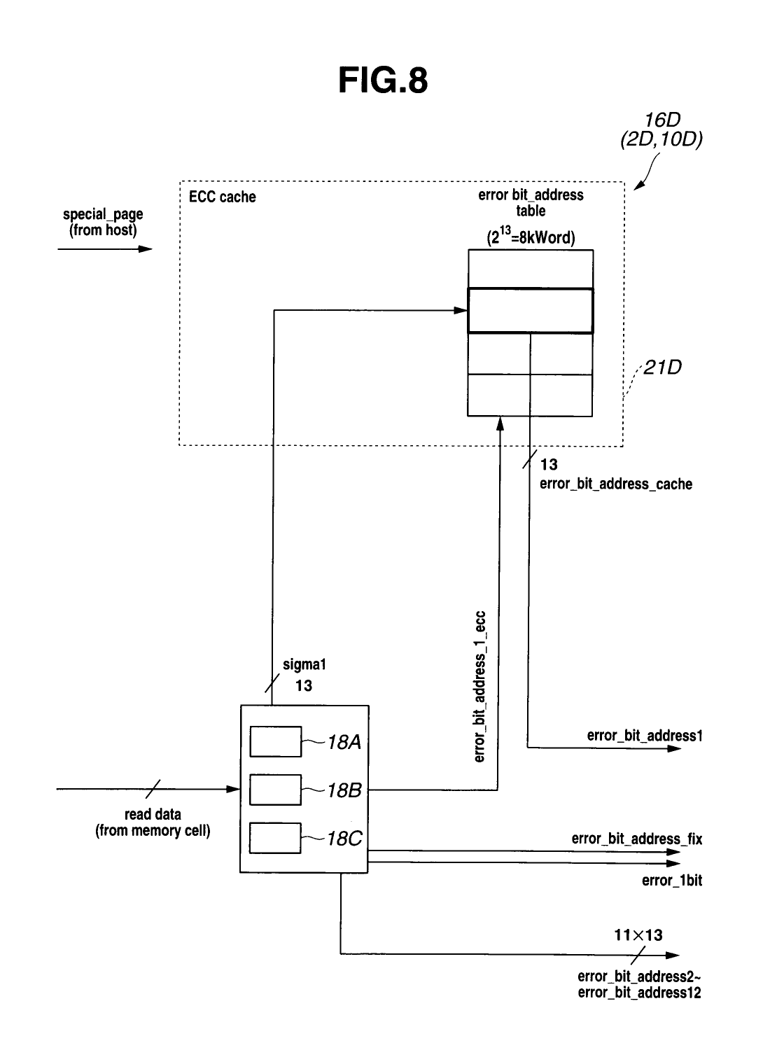

Next, a decoding process performed by an error detector/corrector 16D and the like according to a fifth embodiment of the present invention will be described with reference to FIG. 8. The error detector/corrector 16D and the like according to the fifth embodiment are similar to the error detector/corrector 16 and the like according to the first embodiment. Thus, the same components as those in the first embodiment are denoted by the same reference numerals as the corresponding components in the first embodiment, and description thereof will be omitted.

In relation to the error detector/corrector 16D and the like according to the fifth embodiment, an error location storage unit will be referred to as an ECC cache unit 21D for convenience of explanation, but the error location storage unit is in a tabular form rather than in the form of cache. The error detector/corrector 16D and the like according to the fifth embodiment calculate error bit addresses only for single-bit errors using a table in the ECC cache unit 21D. Specifically, as shown in FIG. 8, using 13 bits of “sigma 1” for a table address, the error detector/corrector 16D and the like store all error bit addresses (2¹³=8 kWords) corresponding to “sigma 1” in the register of the CPU 12, the RAM 13, or the like. The error bit addresses corresponding to “sigma 1” are stored in the table in advance. Of “error_bit_address 1” to “error_bit_address 12,” only “error_bit_address 1” is read out of the table and determined.

The error detector/corrector 16D, a memory controller 10D (see FIGS. 1 and 2), and a semiconductor memory device 1D (see FIGS. 1 and 2) according to the present embodiment not only provide the advantages of the error detector/corrector 16 and the like according to the first embodiment, but also speed up the decoding process when the probability is high that each page contains a single-bit error. Furthermore, the error detector/corrector 16D and the like according to the present embodiment eliminate the need for sigma tags and reduce the capacity of the error address table, i.e., the ECC cache unit 21D, and thereby provide a cost advantage.

### Sixth Embodiment

Next, a decoding process performed by an error detector/corrector 16E and the like according to a sixth embodiment of the present invention will be described. The error detector/corrector 16E and the like according to the sixth embodiment are similar to the error detector/corrector 16 and the like according to the first embodiment. Thus, the same components as those in the first embodiment are denoted by the same reference numerals as the corresponding components in the first embodiment, and description thereof will be omitted.

Whereas the ECC cache unit 21 of the error detector/corrector 16 and the like according to the first embodiment uses error page addresses and the coefficient α as tags for the ECC cache unit, an ECC cache unit 21E of the error detector/corrector 16E and the like according to the sixth embodiment uses only error page addresses as tags.

Thus, the error detector/corrector 16E according to the present embodiment includes the ECC cache unit 21E which stores an error page address which represents a location of a page containing an error and an error bit address which represents an error location by associating the error page address and error bit address with each other, a comparison unit 22E which checks for a match by comparing a page address detected by a syndrome calculation unit 18A and the page address stored in the ECC cache unit 21E, and a first error localization unit 23 which identifies a location of the error bit address stored in the ECC cache unit 21E by being associated with the error page address, as the error location when the comparison unit 22E determines that compared values match.

Consequently, the error detector/corrector 16E, a memory controller 10E (see FIGS. 1 and 2), and a semiconductor memory device 1E (see FIGS. 1 and 2) according to the present embodiment not only provide the advantages of the error detector/corrector 16 and the like according to the first embodiment, but also provide an efficient decoding process.

The error detector/corrector, memory controller, or semiconductor memory device according to the present embodiment operates as follows.
(1) An error detection and correction method including:

a writing step of encoding data inputted from a host and storing the encoded data into a semiconductor memory unit on a page-by-page basis;

determining step of reading the encoded data from the semiconductor memory unit on a page-by-page basis on instructions from the host and determining whether a page to be read is a special page or a regular page rather than a special page;

a regular decoding step of decoding the encoded data using a Chien search method and outputting the decoded data to the host, if it is determined in the determining step that the page to be read is a regular page;

a syndrome calculation step of calculating a syndrome of the encoded data if it is determined in the determining step that the page to be read is a special page;

an error checking step of outputting the data to the host if the syndrome calculated in the syndrome calculation step is zero;

an error location polynomial calculation step of calculating an error location polynomial based on the syndrome if the syndrome calculated in the syndrome calculation step is not zero;

a comparison step of checking for a match by comparing new values with stored values, where the new values are a page address calculated in the syndrome calculation step and a coefficient α of the error location polynomial calculated in the error location polynomial calculation step while the stored values are an error page address and a coefficient α of the error location polynomial, stored in an ECC cache unit;

a simplified error localization step of identifying, as an error location, a location represented by an error bit address stored in the ECC cache unit by being associated with the error page address and the coefficient of the error location polynomial, when it is determined in the comparison step that there is a match between the compared values;

a Chien search step of identifying an error location based on the error location polynomial using a Chien search when it is determined in the comparison step that there is no match;

a caching step of storing the error location identified in the Chien search step, the error page address, and the coefficient α of the error location polynomial in the ECC cache unit; and

an error correction step of correcting an error at the error location identified in the simplified error localization step or the Chien search step and outputting corrected data to the host.
(2) The error detection and correction method according to (1), wherein the special page is a specific page accessed frequently.
(3) The error detection and correction method according to (2), wherein the special page is a specific page containing a small number of errors.
(4) The error detection and correction method according to (2), wherein the special page is a specific page containing a large number of errors.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An error detector/corrector comprising:
an error detection unit configured to detect whether or not there is an error in an encoded data string read on a page-by-page basis;
a polynomial calculation unit configured to calculate an error location polynomial;
an error location storage unit configured to store an error address which represents an error location by associating the error address with at least one of an error page address which represents a location of a page containing an error and a coefficient of the error location polynomial;
a comparison unit configured to check for a match by comparing at least one of an error page address newly detected by the error detection unit and a coefficient of the error location polynomial newly calculated by the polynomial calculation unit with at least one of the error page address and the coefficient of the error location polynomial, already stored in the error location storage unit;
a first error localization unit configured to identify a location of the error address stored in the error location storage unit by being associated with at least one of the error page address and the coefficient of the error location polynomial, as the error location when the comparison unit determines that compared values match;
a second error localization unit configured to calculate an error location from the error location polynomial when the comparison unit determines that the compared values do not match; and
an error correction unit configured to correct any data error at the error location.

2. The error detector/corrector according to claim 1, wherein when the comparison unit determines that the compared values do not match, information in the error location storage unit is updated as an error address using the error location identified by the second error localization unit.

3. The error detector/corrector according to claim 1, wherein the error location storage unit stores the error address in the error location storage unit taking the coefficient of the error location polynomial as a cache address which represents a storage location.

4. The error detector/corrector according to claim 1, wherein the second error localization unit calculates the error location using a Chien search method.

5. The error detector/corrector according to claim 1, wherein the error location storage unit stores the error address on a specific page accessed frequently.

6. The error detector/corrector according to claim 5, wherein the error location storage unit stores the error address on the specific page containing a small number of errors.

7. The error detector/corrector according to claim 5, wherein the error location storage unit stores the error address on the specific page containing a large number of errors.

8. A memory controller comprising:
an error detection unit configured to detect whether or not there is an error in an encoded data string read on a page-by-page basis;
a polynomial calculation unit configured to calculate an error location polynomial;
an error location storage unit configured to store an error address which represents an error location by associating the error address with at least one of an error page address which represents a location of a page containing an error and a coefficient of the error location polynomial;
a comparison unit configured to check for a match by comparing at least one of an error page address newly detected by the error detection unit and a coefficient of the error location polynomial newly calculated by the polynomial calculation unit with at least one of the error page address and the coefficient of the error location polynomial, already stored in the error location storage unit;
a first error localization unit configured to identify a location of the error address stored in the error location storage unit by being associated with at least one of the error page address and the coefficient of the error location polynomial, as the error location when the comparison unit determines that compared values match;
a second error localization unit configured to calculate an error location from the error location polynomial when the comparison unit determines that the compared values do not match; and
an error correction unit configured to correct any data error at the error location.

9. The memory controller according to claim 8, wherein when the comparison unit determines that the compared values do not match, information in the error location storage unit is updated as an error address using the error location identified by the second error localization unit.

10. The memory controller according to claim 8, wherein the error location storage unit stores the error address in the error location storage unit taking the coefficient of the error location polynomial as a cache address which represents a storage location.

11. The memory controller according to claim 8, wherein the second error localization unit calculates the error location using a Chien search method.

12. The memory controller according to claim 8, wherein the error location storage unit stores the error address on a specific page accessed frequently.

13. The memory controller according to claim 12, wherein the error location storage unit stores the error address on the specific page containing a small number of errors.

14. The memory controller according to claim 12, wherein the error location storage unit stores the error address on the specific page containing a large number of errors.

15. A semiconductor memory device comprising:
an error detection unit configured to detect whether or not there is an error in an encoded data string read on a page-by-page basis;
a polynomial calculation unit configured to calculate an error location polynomial;
an error location storage unit configured to store an error address which represents an error location by associating the error address with at least one of an error page address which represents a location of a page containing an error and a coefficient of the error location polynomial;
a comparison unit configured to check for a match by comparing at least one of an error page address newly detected by the error detection unit and a coefficient of the error location polynomial newly calculated by the polynomial calculation unit with at least one of the error page address and the coefficient of the error location polynomial, already stored in the error location storage unit;
a first error localization unit configured to identify a location of the error address stored in the error location storage unit by being associated with at least one of the error page address and the coefficient of the error location polynomial, as the error location when the comparison unit determines that compared values match;
a second error localization unit configured to calculate an error location from the error location polynomial when the comparison unit determines that the compared values do not match; and
an error correction unit configured to correct any data error at the error location.

16. The semiconductor memory device according to claim 15, wherein when the comparison unit determines that the compared values do not match, information in the error location storage unit is updated as an error address using the error location identified by the second error localization unit.

17. The semiconductor memory device according to claim 15, wherein the error location storage unit stores the error address in the error location storage unit taking the coefficient of the error location polynomial as a cache address which represents a storage location.

18. The semiconductor memory device according to claim 15, wherein the second error localization unit calculates the error location using a Chien search method.

19. The semiconductor memory device according to claim 15, wherein the error location storage unit stores the error address on a specific page accessed frequently.
